(19) United States
(12) Patent Application Publication
(10) Pub. No.: US 2014/0132856 A1
(43) Pub. Date: May 15, 2014

(54) STRENGTHENED GLASS ARTICLE AND TOUCH-SENSITIVE DEVICE

(71) Applicant: Wintek Corporation, Taichung City (TW)

(72) Inventors: Jeng-Jye Hung, Tai Ping City (TW); Siang-Lin Huang, Taichung City (TW); Wen-Chun Wang, Taichung City (TW); Kuo-Chang Su, Shan Hua Town (TW); Hen-Ta Kang, Taichung (TW)

(73) Assignee: Wintek Corporation, Taichung City (TW)

(21) Appl. No.: 14/075,604

(22) Filed: Nov. 8, 2013

(30) Foreign Application Priority Data
Nov. 9, 2012 (TW) 101141850
Oct. 18, 2013 (TW) 102137729

(51) Int. Cl. G06F 3/041; C03C 25/10

(52) U.S. Cl. CPC G06F 3/041; C03C 25/10
USPC 349/12; 428/192; 428/194; 428/172; 428/161; 428/189

(57) ABSTRACT

A strengthened glass article includes a glass block having at least one cut facet, a reinforcement layer, and a sheltering layer. The reinforcement layer is at least disposed on at least a part of the cut facet. The sheltering layer is at least disposed on at least a part of a periphery of the glass block and covers at least a part of the reinforcement layer.

### BACKGROUND OF THE INVENTION

a. Field of the Invention

The invention relates to a strengthened glass article and a touch-sensitive device having the strengthened glass article.

b. Description of the Related Art

Generally, conventional methods for strengthening glass mainly include a physically strengthening treatment and a chemically strengthening treatment. For example, in a typical chemically strengthening treatment, an ion-exchange phenomenon occurs in the glass skin to form a chemically strengthened layer. Under the circumstance, a compression stress layer is correspondingly formed as a result of the chemically strengthened layer and is capable of constraining the growth of cracks in the glass skin to enhance the glass strength. In a typical process of performing a chemically strengthening treatment, a glass substrate to be strengthened is entirely dipped into high-temperature potassium molten salts for ion-exchange. However, it is difficult to strengthen only a part of a glass substrate using such process, and the high-temperature may damage a coating on the glass substrate. Further, if the chemically strengthened glass substrate undergoes subsequent machining processes, the machining processes may remove a part of the strengthened layer already formed on the glass substrate or create a newly-born surface without the strengthened layer. Therefore, for a strengthened glass substrate having been subject to machining processes, it is relatively easy to grow cracks on a surface area without the strengthened layer to therefore reduce the strength of glass.

### BRIEF SUMMARY OF THE INVENTION

The invention provides a strengthened glass article having a reinforcement layer and a sheltering layer covering the reinforcement layer to enhanced glass strength.

The invention further provides a touch-sensitive device having the strengthened glass article.

Other objects and advantages of the invention can be better understood from the technical characteristics disclosed by the invention.

According to an embodiment of the invention, a strengthened glass article includes a glass block having at least one cut facet, a reinforcement layer, and a sheltering layer. The reinforcement layer is at least disposed on at least a part of the cut facet, and the sheltering layer is at least disposed on at least a part of a periphery of the glass block and covers at least a part of the reinforcement layer.

According to another embodiment of the invention, a strengthened glass article includes a glass block, a reinforcement layer, and a sheltering layer. The glass block is cut from a mother glass substrate given a preliminary chemically strengthening treatment, the glass block has a preliminary strengthened surface area and at least one newly-born surface area, and the newly-born surface area is formed as a result of a machining or material removing treatment. The reinforcement layer is at least disposed on at least a part of the newly-born surface area, and a sheltering layer is at least disposed on at least a part of a periphery of the glass block and covers at least a part of the reinforcement layer.

According to another embodiment of the invention, a touch-sensitive device includes a glass block, a touch-sensing structure, a reinforcement layer, a decorative layer, and a sheltering layer. The glass block is cut from a mother glass substrate given a preliminary chemically strengthening treatment, the glass block has a preliminary strengthened surface area and at least one newly-born surface area, and the newly-born surface area is formed as a result of a machining or material removing treatment. The touch-sensing structure is disposed on the glass bloc, and the reinforcement layer is at least disposed on at least a part of the newly-born surface area. The decorative layer is disposed on the glass block, and a gap region is formed between an outer edge of the decorative layer and an outer edge of the reinforcement layer. The sheltering layer is at least disposed on the glass block and covers the gap region at least in part.

According to another embodiment of the invention, a touch-sensitive device includes a glass block, a touch-sensing structure, a reinforcement layer, a decorative layer, and a sheltering layer. The glass block has at least one cut facet, and the touch-sensing structure is disposed on the glass block. The reinforcement layer is at least disposed on at least a part of the cut facet of the glass block, the decorative layer is disposed on at least a part of a periphery of the glass block, and the gap region is formed between an outer edge of the decorative layer and the cut facet of the glass block. The sheltering layer is disposed on the glass block and covers the gap region at least in part.

In one embodiment, the glass-strengthening coating material may be applied to a part or the entire area of glass to be strengthened by coating or dipping to achieve locally or wholly chemically strengthening. For example, a chemically strengthened layer may not be formed in some surface area of a glass substrate given a preliminary chemically strengthening treatment, or a glass substrate given a preliminary chemically strengthening treatment may be subject to at least one machining or material removing treatment to form a newly-born surface area without a chemically strengthened layer. The glass-strengthening coating material may be applied to the aforementioned surface area without a chemically strengthened layer or the newly-born surface area to provide chemically strengthening effects. Moreover, except for applying the coating material to part of a strengthened glass substrate to provide partially reinforced effects, the coating material may be applied to the entire surface area of a strengthened or non-strengthened glass substrate according to actual demands. Certainly, the reinforcement layer formed as a result of a cured glass-strengthening coating material may be also disposed on an area that has been strengthened.

According to the above embodiments, a glass-strengthening coating material is used to form a chemically strengthened layer on a newly-born surface area or to reinforce the original strengthened layer that is weaken or removed in part as a result of machining or material removing treatments. Therefore, a strengthened layer is formed on the entire surface to further enhance the overall strength. Since the glass-strengthening coating material may be disposed on a glass substrate by coating, it becomes easier to give the glass substrate local reinforcement. Besides, the glass-strengthening coating material may fill cracks in the glass skin to further enhance glass strength. Further, the light-shielding sheltering layer may, entirely or at least in part, cover the gap region between an outer edge of the decorative layer and an outer edge of the reinforcement layer to relieve or avoid periphery light leakage and provide harmonious visual effects. Moreover, the sheltering layer may be disposed on the periphery of the touch-sensitive device to provide periphery protection for the wiring structure on a cover glass and avoid side scrapes on the decorative layer to improve production reliability. The glass-strengthening coating material may be applied to a cut facet of a glass block to form a reinforcement layer to provide at least one of cushion, anti-shake and strengthening effects. Also, the sheltering layer may extend to cover an outer edge of the reinforcement layer to further enhance glass strength.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating the effect of a glass-strengthening coating material according to an embodiment of the invention.

FIG. 2 shows a schematic diagram illustrating a machining or material removing treatment and a secondary chemically strengthening treatment on a glass substrate according to an embodiment of the invention.

FIG. 3 shows a schematic diagram illustrating a machining or material removing treatment and a secondary chemically strengthening treatment on a glass substrate according to another embodiment of the invention.

FIG. 4 shows a schematic diagram illustrating a machining or material removing treatment and a secondary chemically strengthening treatment on a glass substrate according to another embodiment of the invention.

FIG. 5 shows a schematic diagram illustrating a machining or material removing treatment and a secondary chemically strengthening treatment on a glass substrate according to another embodiment of the invention.

FIG. 6 shows a schematic cross-section illustrating a cover lens provided with a decorative layer and in combination with a touch-sensing structure to form a display device according to an embodiment of the invention.

FIG. 7 shows a plan view illustrating the cover lens and touch-sensing structure of FIG. 6 according to an embodiment of the invention.

FIG. 8 shows a plan view illustrating the cover lens and touch-sensing structure of FIG. 6 according to another embodiment of the invention.

FIG. 9 shows a schematic cross-section of a cover lens having a curved side surface and being combined with a touch panel and a display device according to an embodiment of the invention.

FIG. 10 shows a schematic cross-section of a display device having a touch-sensing structure on a top substrate or a sealing cap according to an embodiment of the invention.

FIG. 11 shows a schematic cross-section of a touch-sensing structure being disposed on a cover lens and a substrate according to an embodiment of the invention.

FIG. 12 shows a schematic cross-section of an organic light emitting diode display device having a touch-sensing structure being disposed on a sealing cap according to an embodiment of the invention.

FIG. 13 shows a schematic cross-section of a cover lens serving as a sealing cap of an organic light emitting diode display device and having a touch-sensing structure according to an embodiment of the invention.

FIG. 14A shows a schematic diagram of a touch-sensitive device according to another embodiment of the invention. FIG. 14B shows a partial schematic diagram of a touch-sensing structure of the touch-sensitive device shown in FIG. 14A.

FIG. 15 shows a schematic diagram of a touch-sensitive device according to another embodiment of the invention.

FIG. 16 shows a schematic diagram of a touch-sensitive device according to another embodiment of the invention.

FIG. 17 shows a schematic diagram of a touch-sensitive device according to another embodiment of the invention.

FIG. 18 shows a schematic diagram of a touch-sensitive device according to another embodiment of the invention.

FIG. 19 shows a schematic diagram of a touch-sensitive device according to another embodiment of the invention.

FIG. 20 shows a schematic diagram of a touch-sensitive device according to another embodiment of the invention.

FIGS. 21A to 21D show schematic diagrams illustrating relative positions of an ink layer, an infrared light transmitting layer and a reinforcement layer according to various embodiments of the invention.

FIGS. 22A to 22D show schematic diagrams illustrating relative positions of an ink layer, an infrared light transmitting layer and a reinforcement layer according to various embodiments of the invention.

FIG. 23 shows a schematic diagram of a touch-sensitive device according to another embodiment of the invention.

FIG. 24 shows a schematic diagram of a touch-sensitive device according to another embodiment of the invention.

FIG. 25 shows a schematic diagram of a touch-sensitive device according to another embodiment of the invention.

FIG. 26 shows a schematic diagram illustrating etched notch structures according to an embodiment of the invention.

FIG. 27 shows a schematic diagram of a touch-sensitive device according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

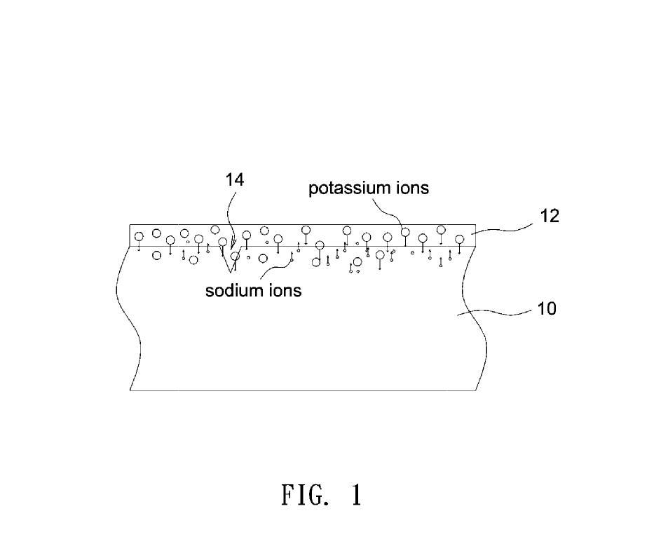

As shown in FIG. 1, according to an embodiment of the invention, a glass-strengthening coating material 12 is silicon oxide sol-gel (SiO2 sol-gel) including potassium salt. When the glass-strengthening coating material 12 is coated on a surface of a glass substrate 10, potassium ions of the glass-strengthening coating material 12 and sodium ions on the skin of the glass substrate 10 perform ion-exchange after being heated to form a chemically strengthened layer. Under the circumstance, a compression stress layer is formed on the skin of the glass substrate 10, and a tensile stress is correspondingly formed inside the glass substrate 10 to compensate the compression stress of the compression stress layer. Therefore, the glass-strengthening coating material 12 together with the chemically strengthened layer forms a reinforcement layer to locally or entirely enhance the strength of the glass substrate 10. Further, a thicker compression stress layer may increase the capability of constraining the growth of cracks to much more strengthen the glass substrate 10 and increase the resistance to an impact of a foreign body. In addition, a silica layer contained in the glass-strengthening coating material 12 may also provide the effect of filling cracks 14 in the glass skin.

### Formulation Example 1

The glass-strengthening coating material 12 is inorganic polymer, preferably comprising silicon oxide sol-gel (SiO2 sol-gel) and potassium salt, and the SiO2 sol-gel is derived from organic silane and formed by a sol-gel method. Constitution details are described in the following:

(1) SiO2 sol-gel, where SiO2 sol-gel is derived by hydrolysis and polymerization of a silane precursor and the silane precursor is, for example, tetraethoxysilane, tetramethoxysilane, vinyltrimethoxysilane or methyltrimethoxysilane; and

(2) 1-30 wt % of potassium salt, where the potassium salt includes, for example, at least one of potassium dihydrogen phosphate, potassium manganate, potassium ferrate, potassium nitrate, potassium formate, potassium ferric oxalate, and aluminium potassium sulfate. The potassium salt is used to realize ion-exchange to form a chemically strengthened layer. Besides, the dissolved potassium salt may form ions used to prevent crosslinking between molecules so as to prolong the time for sol becoming gel; that is, the storage life of the coating material.

The glass-strengthening coating material 12 may be made from the aforementioned raw materials at pH 1-4, and a curing (hardening) temperature of the glass-strengthening coating material 12 may be 100-480 [symbol] .

Certainly, in an alternate embodiment, potassium salt may be excluded and only the silica layer is used to provide the effects of filling cracks in the glass skin and increasing the resistance to an impact of a foreign body. Besides, the inorganic polymer is not limited to silicon oxide sol-gel and may be selected from other organic silanes. Preferably, the inorganic polymer is derived from silicon alkoxides and made by a sol-gel method. In addition, the inorganic polymer may be aluminum silicates having a three-dimensional structure.

### Formulation Example 2

The glass-strengthening coating material is organic/inorganic hybrid polymer, comprising:

(1) silicon oxide sol-gel (SiO2 sol-gel), where SiO2 sol-gel is derived by hydrolysis and polymerization of a silane precursor and the silane precursor is, for example, tetraethoxysilane, tetramethoxysilane, vinyltrimethoxysilane or methyltrimethoxysilane;

(2) acrylates, such as 2-hydroxyethyl methacrylate or dipentaerythritol hexacrylate, where acrylates may be added after the hydrolyzing process of the silicon oxide sol-gel preparation is performed to hybrid with silicon oxide sol-gel to form acrylate/silicon oxide hybrid material, thus increasing toughness of the coating material and the capability to absorb impact forces; and

(3) 1-30 wt % of potassium salt, where the potassium salt includes, for example, at least one of potassium dihydrogen phosphate, potassium manganate, potassium ferrate, potassium nitrate, potassium formate, potassium ferric oxalate, and aluminium potassium sulfate.

The glass-strengthening coating material 12 may be made from the aforementioned raw materials at pH 1-4, and a curing (hardening) temperature of the glass-strengthening coating material 12 may be 100-480° C.

Certainly, in an alternate embodiment, potassium salt may be excluded and only the acrylate/silicon oxide hybrid material is added to increase toughness of the coating material, as compared with the formulation example 1. In addition, other organic/inorganic hybrid polymers formed by various resins (for example, PU, silica gel, epoxy, adamantine, PC, PE, PS resins, etc.) modified by silicon, silane or siloxane may also be used.

### Formulation Example 3

The glass-strengthening coating material is organic polymer, preferably a UV curable resin that is a photo-polymerizable resin, and the UV curable resin may be an acrylic resin or an epoxy resin. The acrylic UV curable resin generally includes acrylaic oligomers or monomers, photo-initiator, and other additives, where the oligomers or monomers contain acrylic moiety. When light induces the photo-initiator to generate free radicals, the acrylic moiety may react with the radicals to achieve the purpose of photo-curing or hardening. The epoxy UV curable resin generally includes resin, photo-initiator, filler, and other additives. After the photo-initiator absorbs light, a series of reactions occur to form proton acid and thus to initiate a photo-curing reaction. It should be noted that the photo-polymerizable resin as recited in the above embodiment may be also thermally polymerizable. Certainly, the organic polymer according to the invention may be selected from various thermo-polymerizable resins, such as acrylic thermosetting resins, thermo-curable PU resins, or thermo-curable epoxy resins. The thermo-polymerizable resins are not described in detail here as they are well-known in the art.

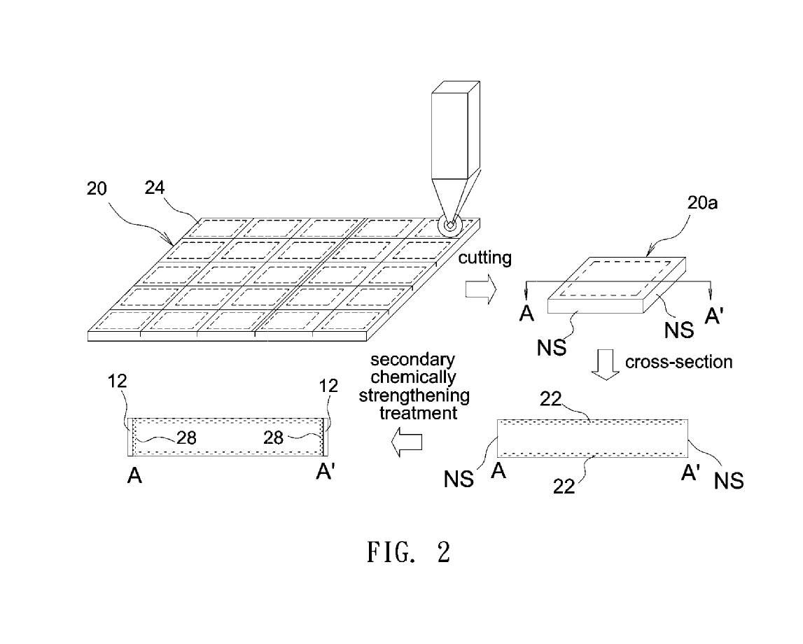

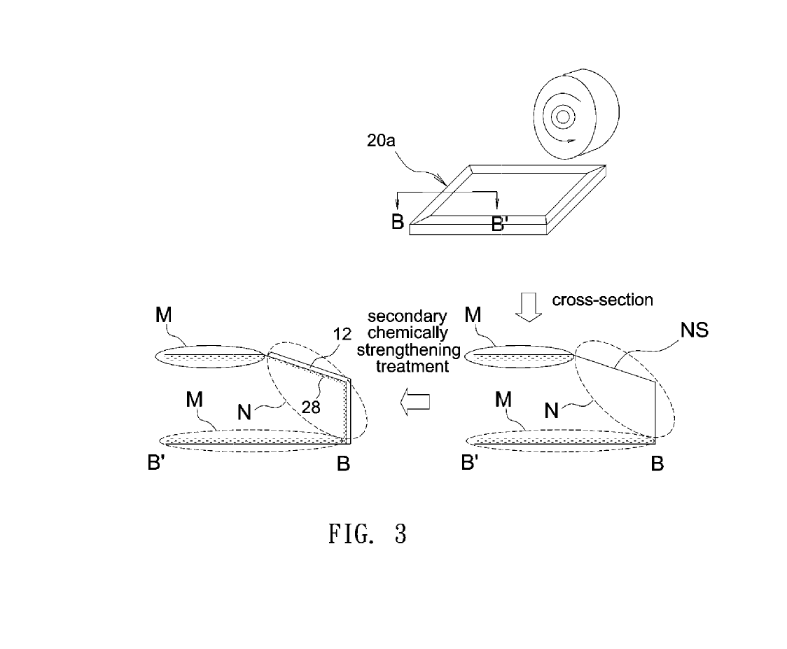

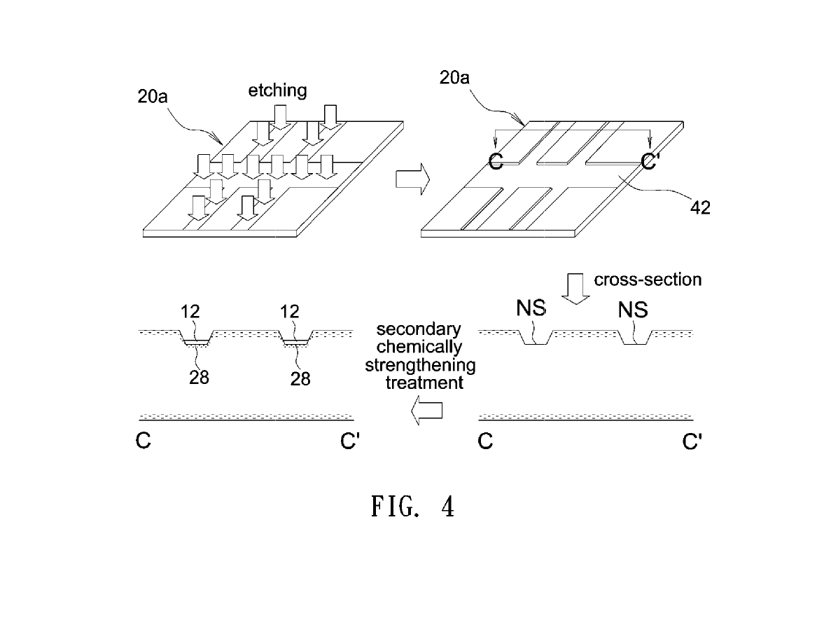

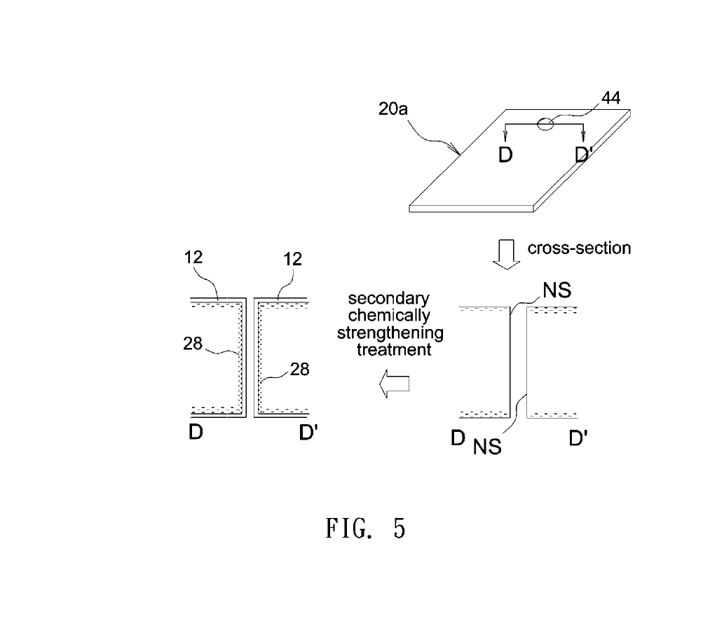

The chemically strengthening effects of a glass-strengthening coating material are exemplified in the following embodiments, where the glass-strengthening coating material is applied to a strengthened mother glass substrate that has been given a preliminary chemically strengthening treatment and then given at least one machining or material removing treatment. As shown in FIG. 2, a mother glass fabrication process is performed on a strengthened mother glass substrate 20 having been given a preliminary chemically strengthening treatment. Herein, the mother glass fabrication process means necessary processes for producing a finished product and performed on a mother glass substrate. For example, in case a strengthened glass substrate serves as a substrate or a cover lens of a touch panel, the mother glass fabrication process may include a first photolithography process for forming metal traces, a second photolithography process for forming an insulation layer, a third photolithography process for forming multiple first sensing series and second sensing series, and forming a decorative layer by a photolithography, screen printing or ink printing process. In that case, multiple touch-sensing structures 24 to be separated are formed on the strengthened mother glass substrate 20. The material of the decorative layer includes at least one of diamond-like carbon, ceramic, ink, resin and photo resist. Also, the decorative layer may be formed on a touch panel, a display panel, or a cover lens or a glass substrate of other electronic product. Alternatively, in case the strengthened glass substrate serves as a transparent substrate of a display panel, the mother glass fabrication process may include depositing metal and dielectric materials and performing photolithography and etching processes on a strengthened mother glass substrate 20 to form a display unit. The display unit includes, but not limited to, a liquid crystal display (LCD) unit or an organic light-emitting diode (OLED) unit. After the mother glass fabrication process has been carried out, the strengthened mother glass substrate 20 is cut to directly form multiple strengthened glass blocks 20a each having a stack of films. Therefore, a product may be produced by the mother glass fabrication process with simplified procedures and reduced fabrication time and costs. Further, since the aforementioned cutting treatment allows each strengthened glass block 20a to form four newly-born surfaces NS (i.e., four cut facets), and each of the newly-born surfaces NS is not provided with a chemically strengthened layer 22 as a result of the preliminary chemically strengthening treatment. Then, the strengthened glass block 20a is coated with a glass-strengthening coating material 12 to form a chemically strengthened layer 28 on the newly-born surface NS. Therefore, in this embodiment, the glass-strengthening coating material 12 and the chemically strengthened layer 28 together form a reinforcement layer. Note the chemically strengthened layer 28 shown in FIG. 2 is formed inside the glass block 20a because the glass-strengthening coating material 12 react with glass to induce ion-exchange. Alternatively, in case the glass-strengthening coating material 12 does not react with glass to induce ion-exchange, the glass-strengthening coating material 12 is the sole component of a reinforcement layer and is on but not inside the glass block 20a. Through the formation of the reinforcement layer, the entire glass block 20a is strengthened to enhance the overall strength. As shown in FIG. 3, the strengthened glass block 20a may be edged by grinding to form a newly-born surface NS without a chemically strengthened layer or with a slight residue of a chemically strengthened layer. After the strengthened glass block 20a is applied with the glass-strengthening coating material 12, a chemically strengthened layer 28 is similarly formed on the newly-born surface NS. Therefore, according to the above embodiments, a strengthened glass block 20a cut from a mother glass substrate 20 having been given a preliminary chemically strengthening treatment is provided, where the strengthened glass block 20a has a preliminary strengthened surface area M and at least one newly-born surface area N, and the newly-born surface area N is formed as a result of at least one machining or material removing treatment. Further, a chemically strengthened layer 28 is at least formed on the newly-born surface area N by coating the glass-strengthening coating material 12. Besides, except for the newly-born surface area N, the chemically strengthened layer 28 may be optionally formed on part of the preliminary strengthened surface area M, such as being formed in a selected region of the preliminary strengthened surface area M near the newly-born surface area N, to further increase the glass strength of the selected region. If necessary, the glass-strengthening coating material 12 may be applied to the entire surface of the strengthened glass block 20a. Certainly, the machining or material removing treatment is not limited to specific processes, as long as a newly-born surface area N is formed. For example, the strengthened glass block 20a may be, for example, etched (a notch 42 shown in FIG. 4 is etched on the strengthened glass block 20a), drilled (a hole 44 shown in FIG. 5 and penetrating or not penetrating the strengthened glass block 20a), polished or rounded to form a newly-born surface NS, and the glass-strengthening coating material 12 at least covers the newly-born surface area N. Under the circumstance, a chemically strengthened layer and a corresponding compression stress layer are formed on the entire surface of a strengthened glass block 20a to enhance the overall strength. Certainly, the strengthened glass block 20a may be given multiple different machining or material removing treatments, and then the newly-born surface with a final shape is subject to a secondary chemically strengthening treatment. For example, the strengthened glass block 20a is first given machining treatments such as cutting, edging and chamfering operations, and peripheral cracks formed as a result of the machining treatments are removed by etching using an etching agent such as hydrofluoric acid. Accordingly, the bending strength of the machined glass block 20a is increased to eliminate or reduce the formation of cracks on bending the machined glass block 20a. Then, the machined glass block 20a is coated with the glass-strengthening coating material 12 to form a chemically strengthened layer on the entire surface of the strengthened glass block 20a.

In the above embodiments, the glass-strengthening coating material 12 is disposed in the glass skin by coating. However, this in not limited. In an alternate embodiment, the glass substrate may be partially or completely dipped into the glass-strengthening coating material 12 to form a chemically strengthened layer. Alternatively, the glass-strengthening coating material 12 may be disposed on a glass surface by other processing such as injection molding. Besides, according to the above embodiments, the reinforcement layer may be formed solely by the glass-strengthening coating material 12 or by the glass-strengthening coating material 12 and the chemically strengthened layer 28 altogether, depending on whether an ion-exchange reaction occurs.

According to the above embodiments, a glass-strengthening coating material is used to form a chemically strengthened layer on a newly-born surface area or to reinforce the original strengthened layer that is weaken or removed in part as a result of machining or material removing treatments. Therefore, a strengthened layer is formed on the entire surface to further enhance the overall strength. Since the glass-strengthening coating material may be disposed on a glass substrate by coating, it becomes easier to give the glass substrate local reinforcement. Besides, inorganic or organic polymer (such as SiO2 layer or UV curable resin) in the glass-strengthening coating material may fill cracks in the glass skin to further enhance glass strength. In addition, compared with a conventional chemically strengthening treatment where a glass substrate is dipped into high-temperature potassium molten salt, since a curing temperature for the glass-strengthening coating material containing potassium salt may be lowered to about 100 [symbol] , the low curing temperature does a coating layer on the glass substrate no harm to increase production yields and reliability.

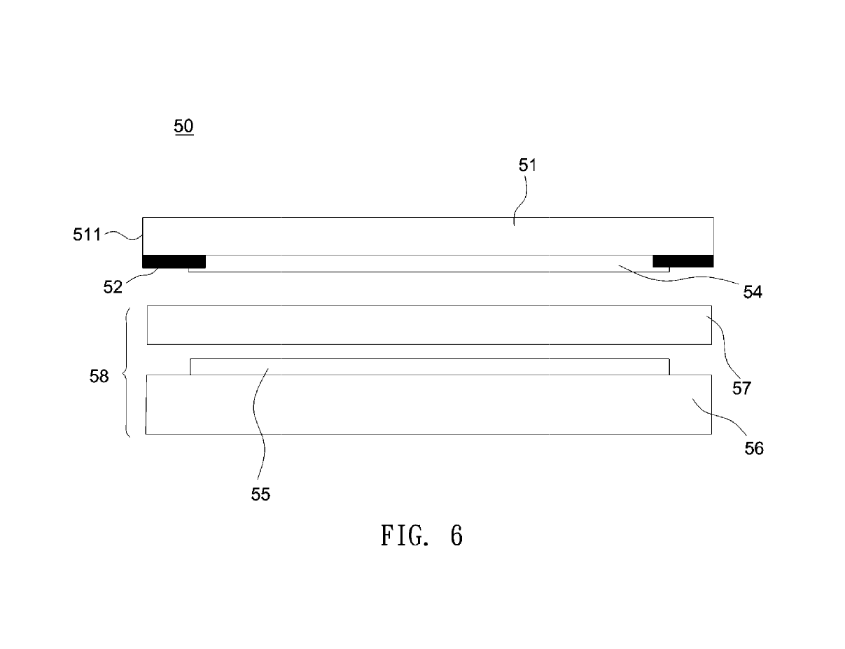

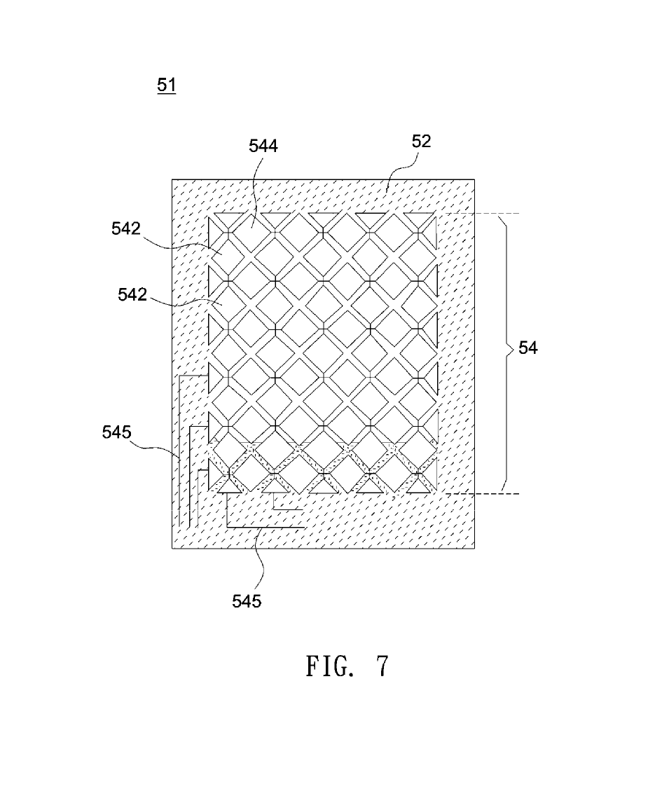

As shown in FIG. 6, a touch-sensitive display device 50 includes a cover lens 51 and a display device 58. Before cutting a mother glass substrate, the mother glass substrate may undergo a mother glass fabrication process, such as film deposition, photolithography, etching, screen printing or ink printing to form a decorative layer 52 and a touch-sensing structure 54. Then, the mother glass substrate is cut to form multiple strengthened glass blocks 20a each serving as a cover lens 51. A side surface 511 of the cover lens 51 is optionally given an etching treatment and a secondary chemically strengthening treatment (such as coating the glass-strengthening coating material 12) to obtain a strengthened cover lens 51. Similarly, display units 55 may be formed on a mother glass substrate by aforementioned mother glass fabrication process, and the mother glass substrate is cut to form multiple strengthened glass blocks 20a each functioning as an array substrate. The array substrate may serve as a bottom substrate 56 of an LCD device or an OLED device, and the array substrate may combine with a color filter substrate or a sealing cap 57 to form a display device 58. Typically, a touch-sensing structure is formed by patterning an electrode layer. For example, as shown in FIG. 7, a touch-sensing structure 54 mainly includes multiple first sensing series 542 and multiple second sensing series 544 oriented to cross over the first sensing series 542 at crossover locations. A dielectric layer that may include a plurality of insulators isolated from each other is disposed in the crossover locations to separate the first sensing series 542 and the second sensing series 544 at the crossover locations. Besides, connection wires of the first sensing series 542 or the second sensing series 544 may be disposed beyond or below the dielectric layer, and the connection wires may be made of a transparent conductive material or metal. Conductive traces 545 are formed on the decorative layer 52 or serve as connection wires inside the sensing series 542 or the sensing series 544. The conductive traces 545 may be metallic or transparent. It should be noted that only a part of the conductive traces 545 is depicted, and other part of the conductive traces 545 is omitted from FIG. 7.

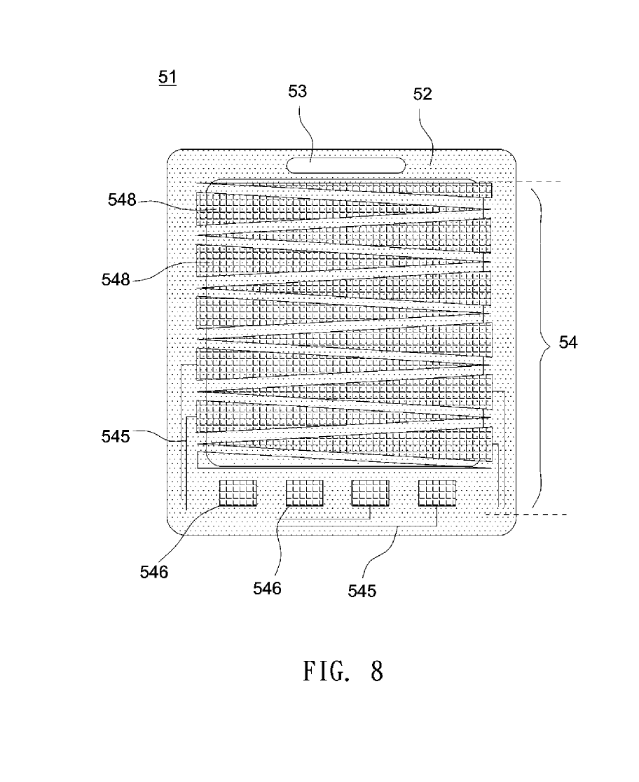

Further, the touch-sensing structure 54 may be formed by patterning a single-layer electrode. For example, as shown in FIG. 8, the touch-sensing structure 54 may include button-type single-layer electrodes 546 or triangle-type single-layer electrodes 548. The button-type single-layer electrode 546 or the triangle-type single-layer electrode 548 may be in the form of a transparent electrode pattern or a mesh-wire pattern shown in FIG. 8. The conductive traces 545 are formed on the decorative layer 52, and the conductive traces 545 may be metallic or transparent. Note only a part of the conductive traces 545 is depicted, and other part of the conductive traces 545 is omitted from FIG. 8. At least one hole 53 is formed in the cover lens 51 and overlaps the decorative layer 52. After an etching process and a secondary chemically strengthening treatment (such as coating the glass-strengthening coating material 12) are performed, the strength of a side wall defining the hole 53 is allowed to be increased. Note the aforementioned patterns formed by transparent electrodes or mesh-wire are not limited to be applied to the touch-sensing structure 54 but may be applied to various embodiments of the invention and various configurations of a touch-sensing structure.

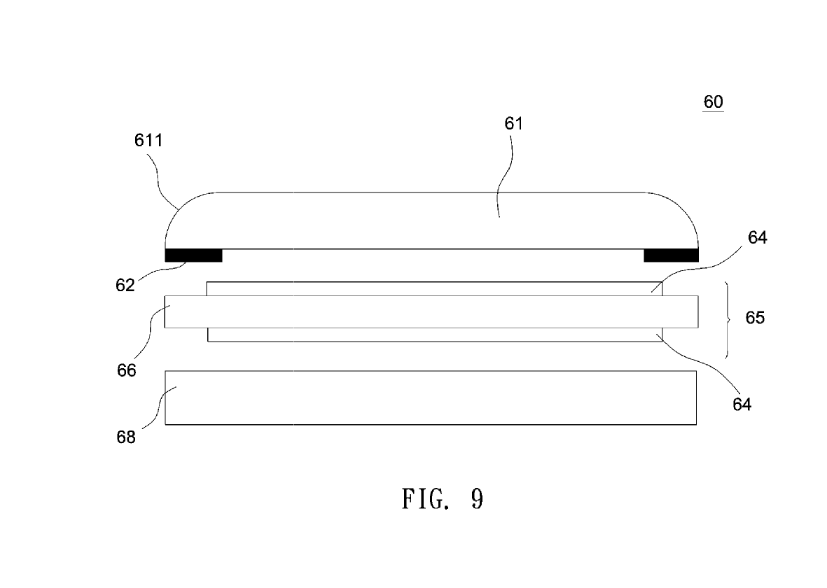

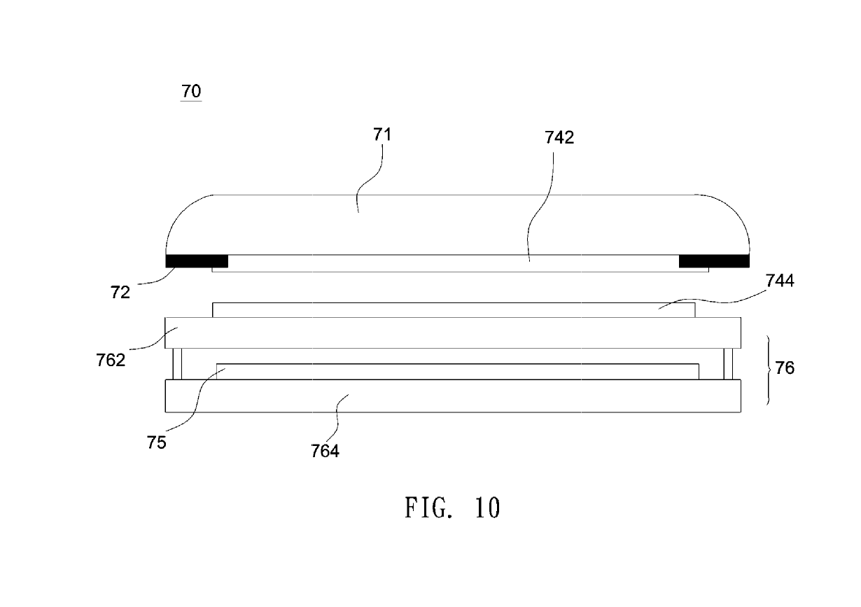

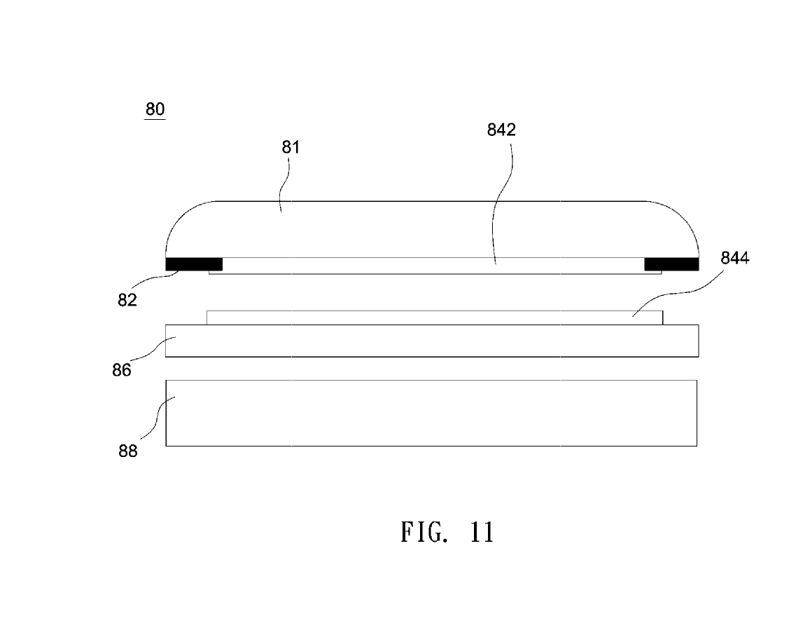

Referring to FIG. 9, in case the strengthened glass block 20a serves as a cover lens, a secondary chemically strengthening treatment may be given to the strengthened glass block 20a having been subject to machining treatments. In this embodiment, at least one side of the cover lens 61 is machined (such as edged and chamfered) to form a curved surface 611, and then the curved surface 611 is given a secondary chemically strengthening treatment (such as coating the glass-strengthening coating material 12). A decorative layer 62 is formed on another surface of the cover lens 61. In this embodiment, a finished cover lens 61, a touch panel 65, and a display device 68 together form a touch-sensitive display device 60, where the touch panel 65 includes a substrate 66 and a touch-sensing structure 64. As shown in FIG. 9, the touch-sensing structure 64 may be, but not limited to, disposed on two sides of the substrate 66. In an alternate embodiment, the touch-sensing structure 64 may be disposed on only one side of the substrate 66.

Referring to FIG. 10, in one embodiment, the strengthened glass block 20a of a touch-sensitive display device 70 may undergo a mother glass fabrication process, such as film deposition, photolithography, etching, screen printing or ink printing to form a decorative layer 72 and a touch-sensing structure 742, and then the mother glass substrate is cut to form multiple small pieces each serving as a cover lens 71. In contrast to above embodiments, another touch-sensing structure 744 according to this embodiment is directly disposed on a color filter substrate 762 of a display device 76, and the touch-sensing structures 742 and 744 together form a touch-sensing device. The touch-sensing structures 742 and 744 may be patterned electrode layers. The display device 76 may further include a bottom substrate 764 and a display unit 75 disposed on the bottom substrate 764. The bottom substrate 764, the display unit 75, and the color filter substrate 762 together form the display device 76.

In an alternate embodiment, the touch-sensing structure 744 may be omitted from the display device 76, and touch-sensing operations are performed only by the touch-sensing structure 742 of the display device 76 with touch-sensing functions. The touch-sensing structure 742 may be in the form of single-layer electrodes or multi-layered electrodes. Besides, in this embodiment, the color filter substrate 762 is replaced with a sealing cap of an OLED. The cover lens 71 is combined with the display device 76 with touch-sensing functions to form a touch-sensitive display device 70 protected by strengthened glass.

As shown in FIG. 111, contrast to the above embodiment, touch-sensing structures 842 and 844 in this embodiment are respectively disposed on a cover lens 81 of a touch-sensitive display device 80 and a transparent substrate 86. In that case, the cover lens 81 is combined with the transparent substrate 86 and a display device 88 to form a touch-sensitive display device 80 protected by strengthened glass.

As shown in FIG. 12, in a touch-sensitive display device 90, touch-sensing structures 942 and 944 are respectively formed on two opposite surfaces of a sealing cap 962 of an OLED device 96. A display unit 95 is disposed on a bottom substrate 964. The sealing cap 962, the bottom substrate 964 or the cover lens 91 may be made of a strengthened glass block and applied with a glass-strengthening coating material 12 exemplified in the above embodiments.

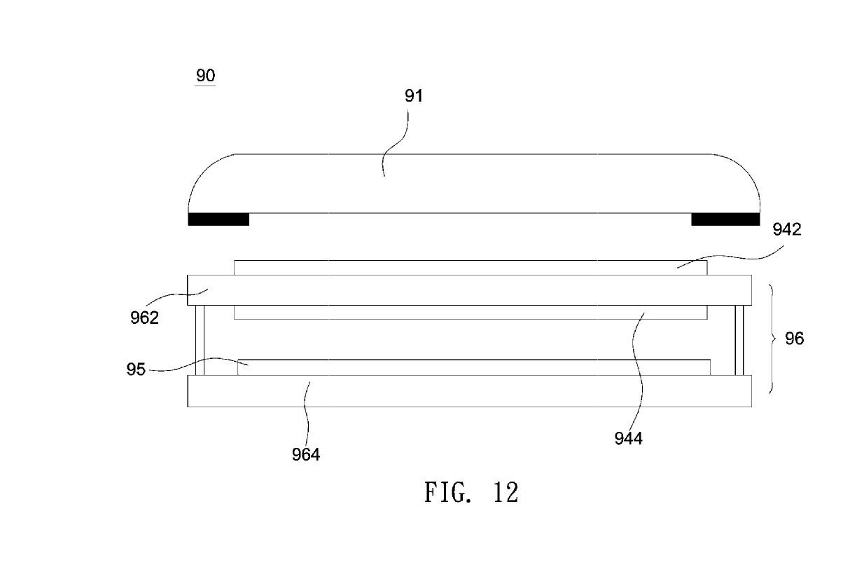

Referring to FIG. 13, in this embodiment, a cover lens 1001 that is strengthened according to the above embodiments serves as a sealing cap of an OLED device 100, and a touch-sensing structure 1004 is formed on the strengthened cover lens 1001. An OLED unit 1005 is disposed on a bottom substrate 1008 and combined with the cover lens 1001 to form a touch-sensitive display device protected by strengthened glass. Though a decorative layer 1002 shown in FIG. 13 is disposed on a top surface of the cover lens 1001, this is not limited. The decorative layer 1002 may be disposed on a bottom surface of the cover lens 1001 instead. Further, a side surface 1006 of the cover lens 1001 may be a planar surface or a curved surface, and the decorative layer 1002 may be disposed on the curved surface.

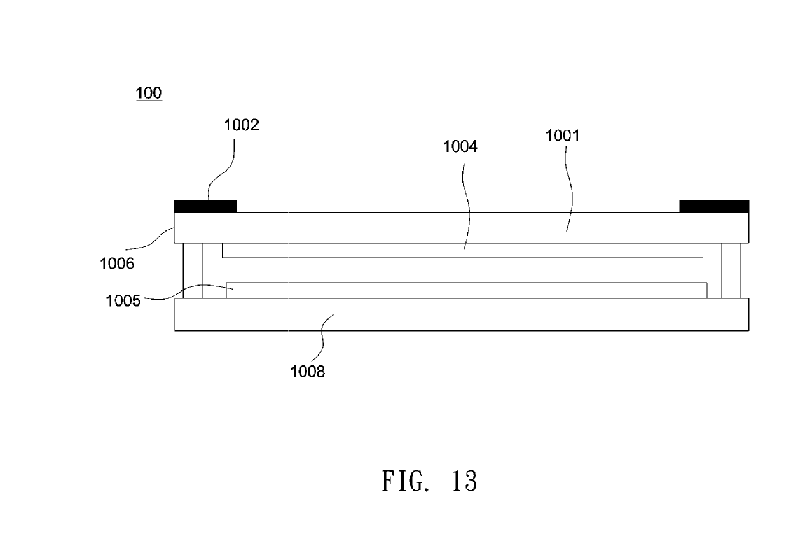

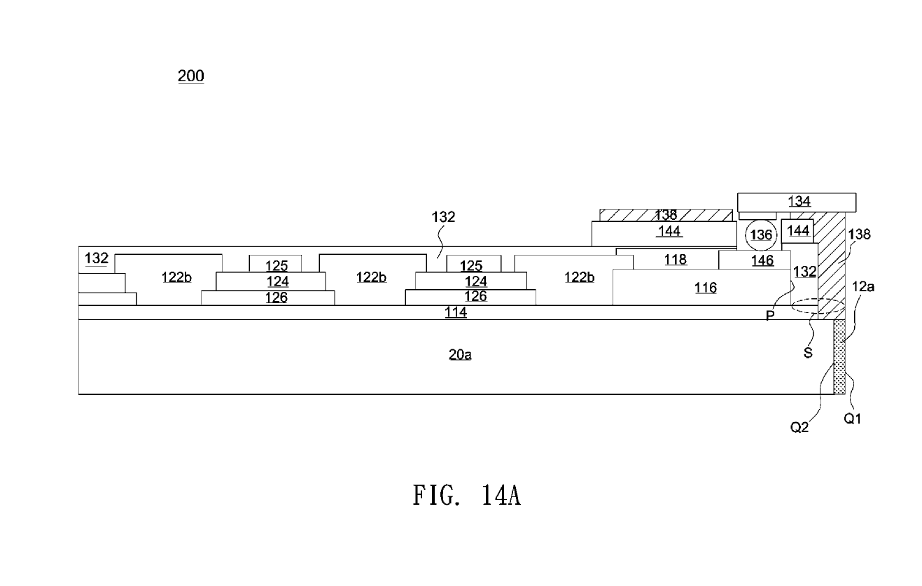

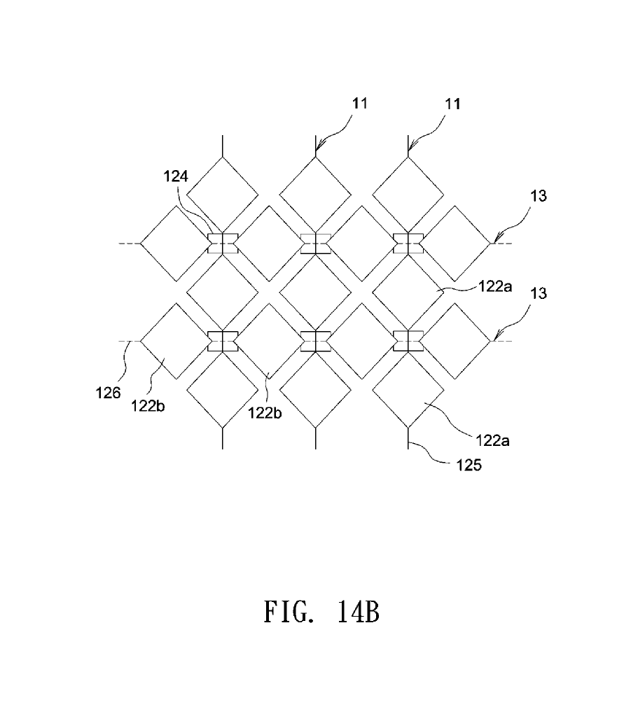

FIG. 14A shows a schematic diagram of a touch-sensitive device according to another embodiment of the invention, where only one side of a touch sensitive device is shown for the sake of clarity. FIG. 14B shows a partial schematic diagram of a touch-sensing structure of the touch-sensitive device shown in FIG. 14A. Referring to FIG. 14A, in one embodiment, a touch-sensitive device 200 includes a glass block 20a and stack-ups on the glass block 20a. A touch-sensing structure is disposed on the glass block 20a to detect the presence and location of a touch event. A decorative layer 116 is disposed on a periphery of the glass block 20a, and a gap region S is formed between the an outer edge P of the decorative layer 116 and an outer edge Q1 of a reinforcement layer 12a. A trace layer 108 including a plurality of traces may be disposed on the decorative layer 116 and hidden by the decorative layer 116, and the touch-sensing structure is electrically connected to the traces. In one embodiment, an insulation layer 114 may be formed on the glass block 20a to cover the glass block 20a. In an alternate embodiment, the touch-sensitive device 200 does not have the insulation layer 114, and the touch-sensing structure is directly formed on the glass block 20a. The decorative layer 116 may be disposed on a periphery of the glass block 20a to shield the traces, and the decorative layer 116 may include at least one of diamond-like carbon, ceramic, ink, resin and photoresist. The touch-sensing structure may be a single-layer electrode structure or a multi-layer electrode structure. For example, as shown in both FIGS. 14A and 14B, the touch-sensing structure is an underground-island electrode structure having multiple first sensing series 11, multiple second sensing series 13, and multiple insulators 124. The first sensing series 11 and the second sensing series 13 are oriented to cross over each other at crossover locations, and the insulators 124 are isolated from each other and disposed in the crossover locations to separate the first sensing series 11 and the second sensing series 13. In this embodiment, each first sensing series 11 may include multiple first electrodes 122a connected with each other by multiple first connecting lines 125, each second sensing series may include multiple second electrodes 122b connected with each other by multiple second connecting lines 126, and each insulator 124 is disposed in a crossover location to separate a first connecting line 125 and a second connecting line 126 at the crossover location. In this embodiment, at least one of the second electrodes 122b may cover a part of one of the insulators 124, and the second electrode 122b may have a stepwise portion touching both a connecting line 126 and an insulator 124. In one embodiment, the second connecting lines 126 may be formed in a fabrication process different to the fabrication process of the first connecting lines 125, the first electrodes 122a and the second electrodes 122b. Besides, the second connecting lines 126 may be disposed on the insulation layer 114 or directly on a surface of the glass block 22a. Note the touch-sensing structure is not limited to an underground-island electrode structure. In an alternate embodiment, the second connecting lines 126 may be connected with each other in the upper portion of the touch-sensing structure to form a bridge-island electrode structure. Further, the touch-sensing structure may be disposed on two opposite sides of the glass block 20a, and each electrode of the touch-sensing structure may have a regular shape such as a diamond, a triangle or a line segment or may have an irregular shape. A passivation layer 132 may cover both a touch-sensing structure within a viewing area and a laminated structure outside the viewing area to protect the entire touch-sensitive device 200. The passivation layer 132 may be made from an inorganic material such as silicide, and the passivation layer 132 may be a transparent layer. Another insulation layer 144 may be disposed on the passivation layer 132 and outside the viewing area, and a thickness of the insulation layer 144 may be 3-100 times greater than a thickness of the passivation layer 132. The insulation layer 144 may be made from an inorganic material or an organic material, and the insulation layer 144 may be a transparent layer. In one embodiment, a transparent conductive layer 146 is formed on the decorative layer 116 and electrically connected to the traces in the trace layer 118. The material of the transparent conductive layer 146 may be an ITO transparent conductive film. An opening may be formed in the passivation layer 132 and the insulation layer 144 at a position overlapping a bonding area of the transparent conductive layer 146 to expose a part of the transparent conductive layer 146. The exposed part of the transparent conductive layer 146 is electrically connected to a transmission device (such as a flexible printed circuit board 134) or an electronic device (such as an IC chip) through an anisotropic conductive film (ACF) 136. Further, a sheltering layer 138 may be disposed on a periphery of the glass block 20a and covers the gap region S at least in part. Therefore, the sheltering layer 138 may cover both at least a part of the glass block 20a and at least a part of the reinforcement layer 12a. An opening may be formed in the sheltering layer 138 at a position overlapping a bonding area of the transparent conductive layer 146. In this embodiment, the sheltering layer 138 may be disposed on the passivation layer 132 and the insulation layer 144. Typically, a cover glass is designed to have various shapes formed by special-shaped edging processing or other machining processing. However, the special-shaped edging processing or other machining processing requires destruction operations that may damage the decorative layer 116. Therefore, the decorative layer 116 is often kept a safe distance away from a lateral side of the glass block 20a. However, as shown in FIG. 14A, since the decorative layer 116 is disposed to be kept a safe distance away from a lateral side Q2 of the glass block 20a, and an outer edge Q1 of the reinforcement layer 12a may also keep a distance from the lateral side Q2 of the glass block 20a (substantially equal to a thickness of the reinforcement layer 12a), the resultant gap region S may cause periphery light leakage. According to the above embodiment, since the sheltering layer 138 may, entirely or at least in part, cover the gap region S between the outer edge P of the decorative layer 116 and the outer edge Q1 of the reinforcement layer 12a and may cover the reinforcement layer 12a entirely or at least in part, the problem of periphery light leakage is relieved or solved. Besides, the sheltering layer 138 may be disposed on the periphery of the touch-sensitive device 200 and above the trace layer 118 to surround the decorative layer 116. This may provide periphery protection for the wiring structure on a cover glass and avoid side scrapes on the decorative layer 116 to improve production reliability. Certainly, the distribution of the sheltering layer 138 is not restricted. In one embodiment, the sheltering layer 138 may be disposed on a part of a periphery of a glass substrate in case the decorative layer 116 is disposed on a corresponding part of the periphery of the glass substrate. Besides, the sheltering layer 138 may be formed from ink. However, the sheltering layer 138 is not limited to be formed from ink and may be any suitable material including, but is not limited to, a translucent material, an opaque material, a material having low light transmittance. For example, the sheltering layer 138 may be formed from at least one of photoresist, diamond-like carbon, ceramic and resin. Moreover, the sheltering layer 138 may be formed from a material capable of transmitting infrared light. Further, the sheltering layer 138 may be a single-layer structure, or the sheltering layer 138 may be a multi-layer structure formed from the same color or different colors and the same material or different materials. Besides, the sheltering layer 138 is not limited to cover the gap region S, as long as light-shielding or peripheral protection effects are provided to improve production reliability. In this embodiment, the lateral side Q2 of the glass block 20a is a newly-born surface area as a result of cutting, and the glass-strengthening coating material 12 may be applied to at least a part of the lateral side Q2 (cut facet) to form a reinforcement layer to provide at least one of cushion, anti-shake and strengthening effects. Note the lateral side Q2 may be formed as a newly-born surface area by other machining processing except for cutting.

As shown in FIG. 15, the reinforcement layer 12a may extend to cover a part of a surface of the glass block 20a facing the decorative layer 116. That is, the reinforcement layer 12a may extend to a surface of the glass block 20a on which the touch-sensing structure is formed to further enhance strengthening effects. Similarly, the sheltering layer 138 is also provided to relieve or avoid peripheral light leakage, and the reinforcement layer 12a is covered and protected by the sheltering layer 138 to a great extent according to this embodiment.

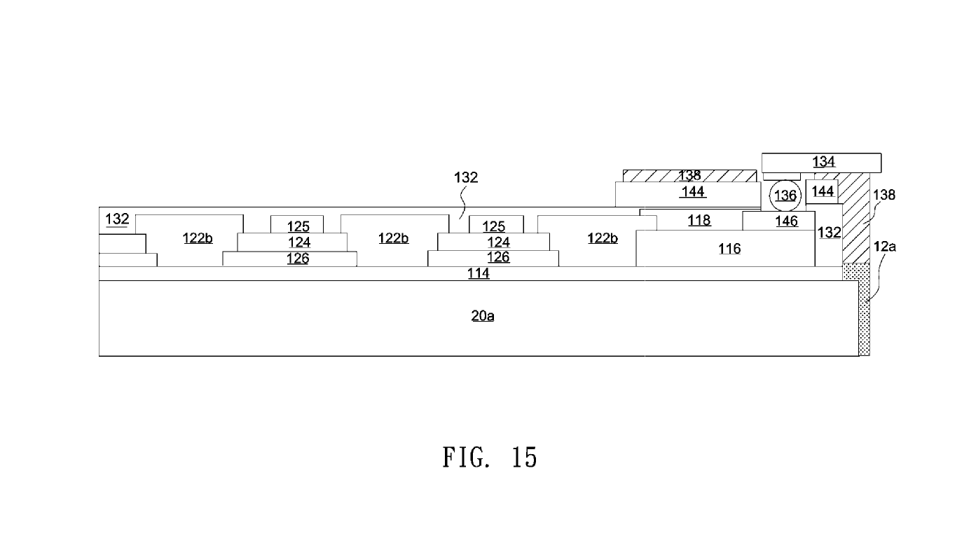

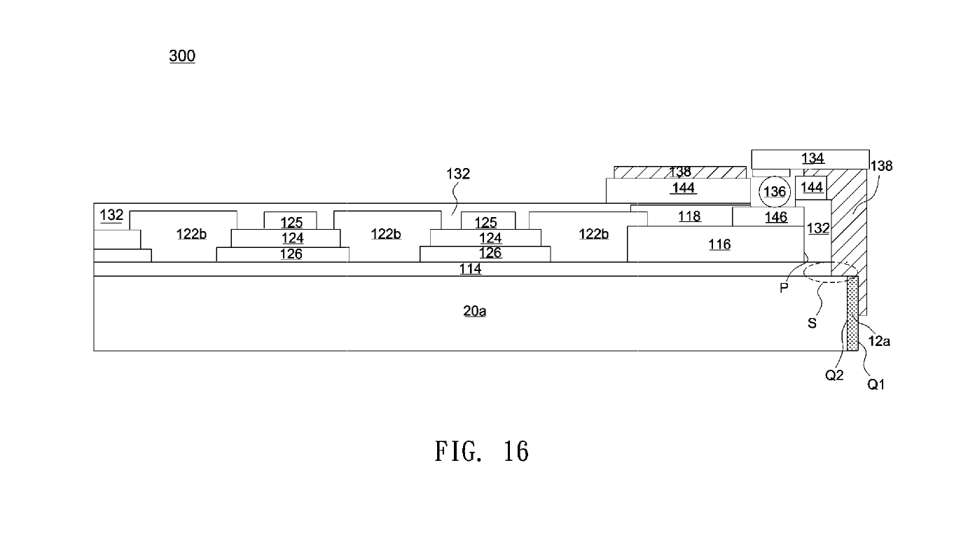

As shown in FIG. 16, in an alternate embodiment, the sheltering layer 138 of the touch-sensitive device 300 extends downwardly to cover at least a part of the lateral side Q2 and the reinforcement layer 12a to increase the coverage of the sheltering layer 138 on the reinforcement layer 12a and enhance the strength of the glass block 20a to a great extent. Similarly, as shown in FIG. 17, the reinforcement layer 12a may extend to cover a part of a surface of the glass block 20a facing the decorative layer 116, and the sheltering layer 138 may also extend downwardly to cover at least a part of the reinforcement layer 12a to protect the reinforcement layer 12a and further enhance the strength of the glass block 20a.

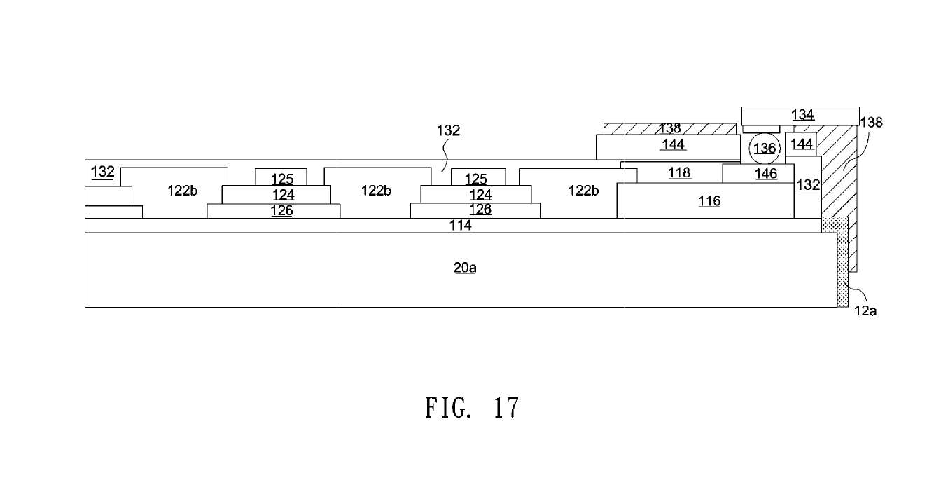

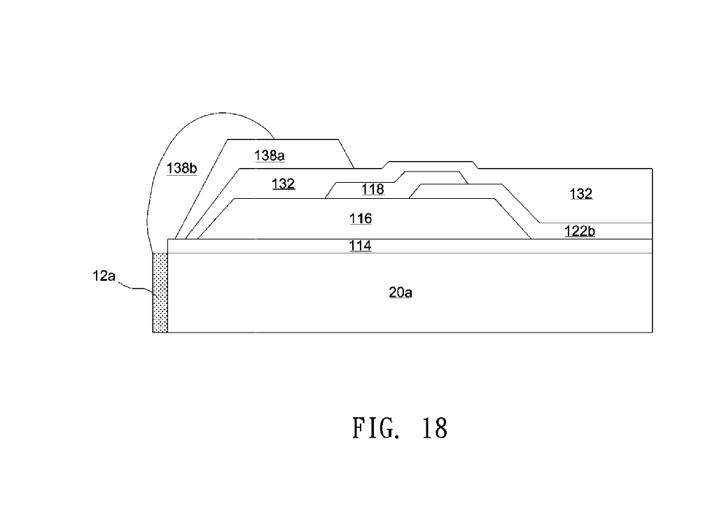

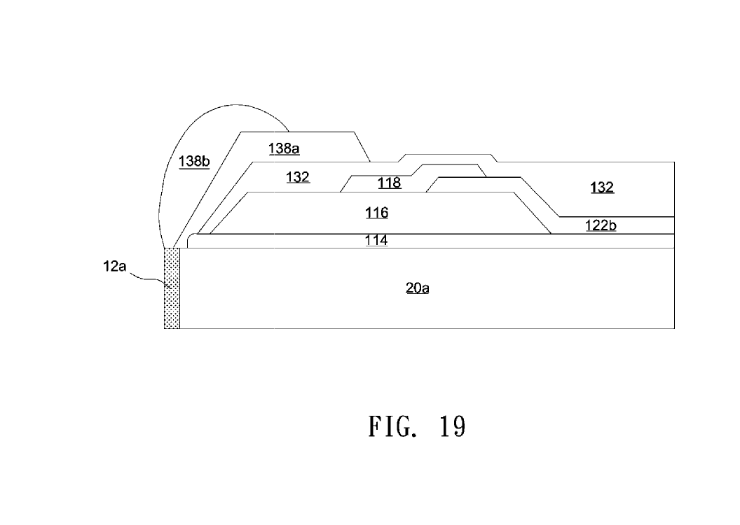

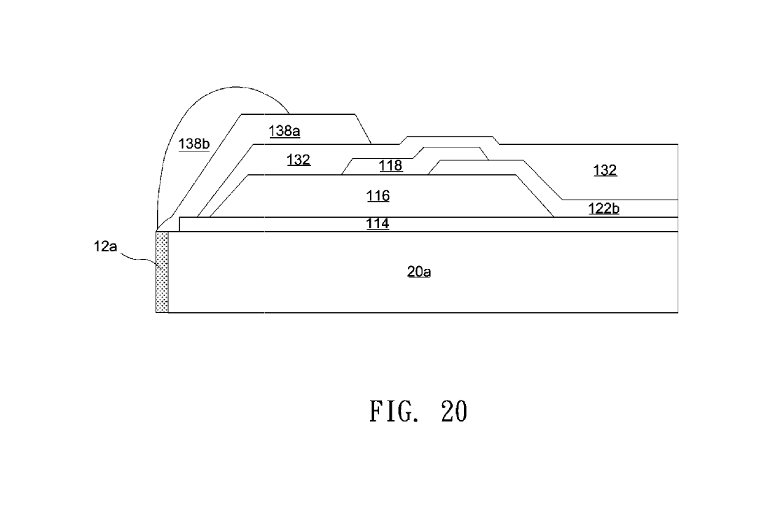

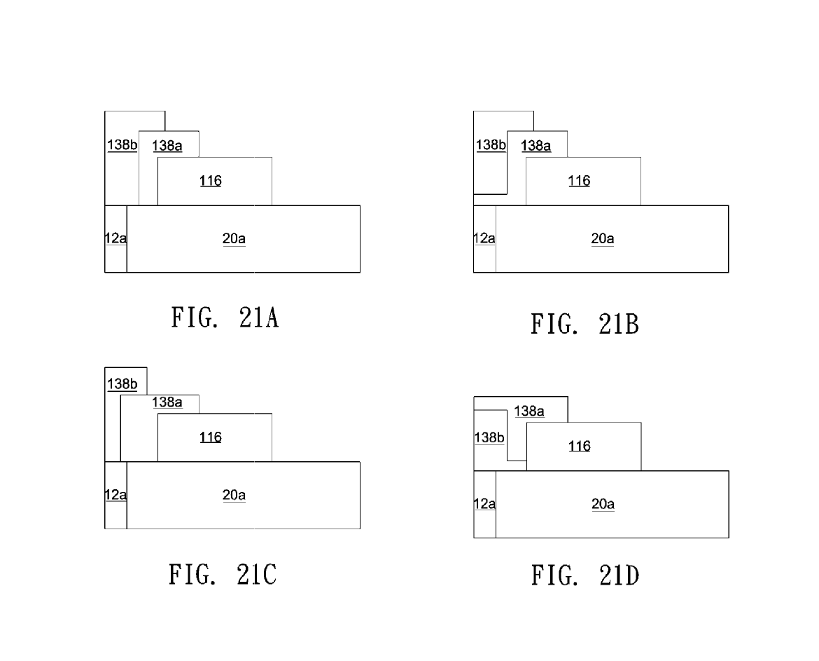

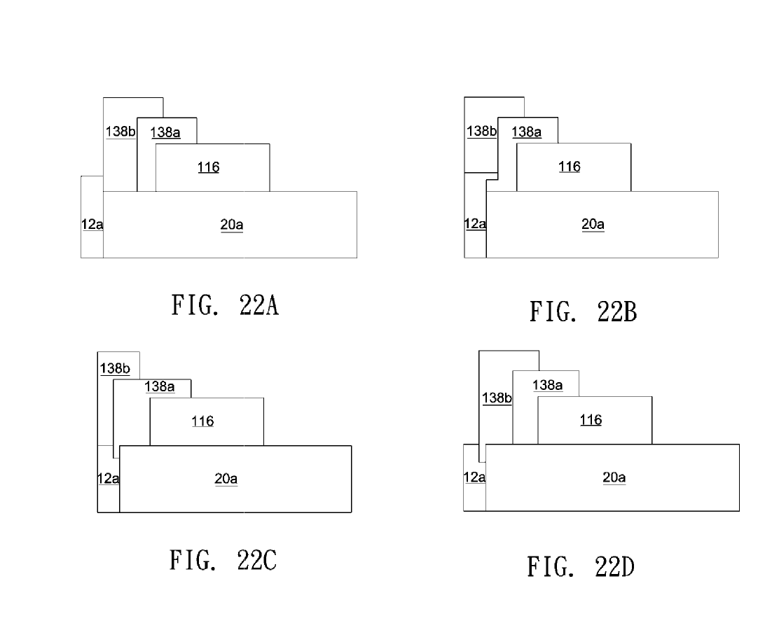

According to the above embodiments, it can be clearly seen the relative positions and distributions of the sheltering layer 138 and the reinforcement layer 12a are not restricted. For example, the sheltering layer 138 may, at least in part, touches or overlaps a side surface of the reinforcement layer 12a. Further, a part of the sheltering layer 138 may touch or overlap the reinforcement layer 12a, and the remaining part of the sheltering layer 138 does not touch or overlap the reinforcement layer 12a. Moreover, the part of the sheltering layer 138 touching or overlapping the reinforcement layer 12a is not specific. As described above, the sheltering layer 138 may be a single-layer structure, or the sheltering layer 138 may be a multi-layer structure formed from the same color or different colors and the same material or different materials. Therefore, in one embodiment shown in FIG. 18, the sheltering layer 138 may be a multi-layer structure including an ink layer 138a and an infrared light transmitting layer 138b. The ink layer 138a may be formed from ink, the infrared light transmitting layer 138b may be formed from a material capable of transmitting infrared light, and the infrared light transmitting layer 138b may cover at least a part of the ink layer 138a. As used herein, the term “infrared light transmitting layer” means a layer having a high light-transmittance of infrared light compared with other wavelength band. For example, the light-transmittance of infrared light may be, but is not limited to, higher than 75%, and the light-transmittance of light within other wavelength band may be, but is not limited to, lower than 20%. In this embodiment, the infrared light transmitting layer 138b may touch the reinforcement layer 12a to cover at least a part of the reinforcement layer 12a, and the ink layer 138a does not touch or overlap the reinforcement layer 12a. In an alternate embodiment, as shown in FIG. 19, the infrared light transmitting layer 138b and ink layer 138a may both touch the reinforcement layer 12a to cover a part of reinforcement layer 12a. As shown in FIG. 20, in an alternate embodiment, the ink layer 138a may extend further to touch the reinforcement layer 12a and allows the ink layer 138a to cover at least a part of reinforcement layer 12a. Though the infrared light transmitting layer 138b does not touch the reinforcement layer 12a, the infrared light transmitting layer 138b is formed in a position overlapping a part of the reinforcement layer 12a to allow both of the infrared light transmitting layer 138b and the ink layer 138a to cover at least a part of reinforcement layer 12a. Therefore, according to various embodiments of the invention, the distribution and relative positions of the ink layer 138a, the infrared light transmitting layer 138b and the reinforcement layer 12a are not restricted. It should be noted that the infrared light transmitting layer may be also provided in front of a functional sensor such as a proximity sensor. For example, the infrared light transmitting layer may be filled in a patterned hole which is defined by a decorative layer and the functional sensor is adjacent to the patterned hole. Thus, we may find that the sheltering layer comprises the infrared light transmitting layer if the material of the infrared light transmitting layer in the infrared light hole is the same as the material of the infrared light transmitting layer in the sheltering layer. FIGS. 21A to 21D show schematic diagrams illustrating relative positions of the ink layer 138a, the infrared light transmitting layer 138b and the reinforcement layer 12a according to various embodiments of the invention, where the ink layer 138a and the infrared light transmitting layer 138b may touch or overlap the reinforcement layer 12a at least in part to allow the sheltering layer 138 to cover at least a part of the reinforcement layer 12a. The ink layer 138a or the infrared light transmitting layer 138b may touch or overlap the reinforcement layer 12a at least in part to form various configurations. For example, only the infrared light transmitting layer 138b touches the reinforcement layer 12a to cover the reinforcement layer 12a (FIG. 21A); only the ink layer 138a touches the reinforcement layer 12a but the infrared light transmitting layer 138b overlaps at least a part of the reinforcement layer 12a to allow both of the ink layer 138a and the infrared light transmitting layer 138b to cover the reinforcement layer 12a (FIG. 21B); the ink layer 138a and the infrared light transmitting layer 138b both touch the reinforcement layer 12a (FIG. 21C); and only the infrared light transmitting layer 138b touches the reinforcement layer 12a but the ink layer 138a overlaps at least a part of the reinforcement layer 12a to allow both of the ink layer 138a and the infrared light transmitting layer 138b to cover the reinforcement layer 12a (FIG. 21D). Further, the reinforcement layer 12a may extend upwardly to touch a part of the infrared light transmitting layer 138b (FIG. 22A) or touch both a part of the ink layer 138a and a part of the infrared light transmitting layer 138b (FIG. 22B) to allow the sheltering layer 138 to cover a part of the reinforcement layer 12a. Alternatively, a part of the ink layer 138a (FIG. 22C) or a part of the infrared light transmitting layer 138b (FIG. 22D) may extend downwardly to reach a lateral side of the glass block 20a and touch the reinforcement layer 12a to allow the sheltering layer 138 to cover a part of the reinforcement layer 12a.

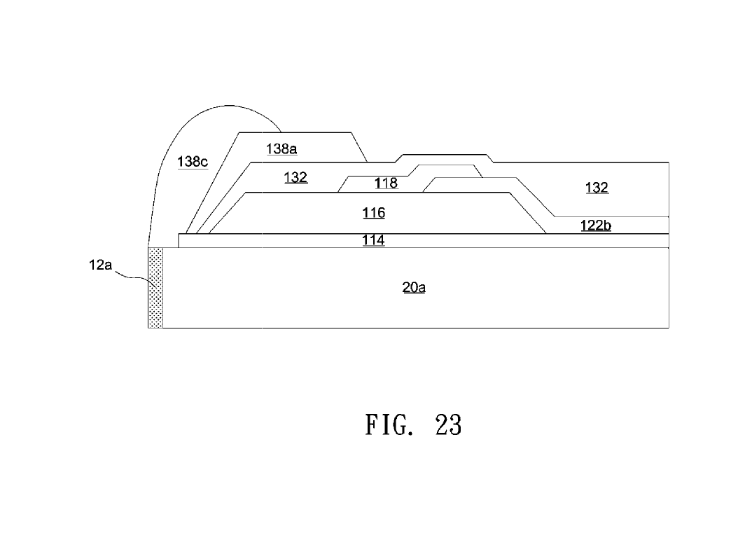

In an alternate embodiment shown in FIG. 23, the sheltering layer 138 may be a multi-layer structure including an ink layer 138a and an LED light transmitting layer 138c. The LED light transmitting layer 138c allows emitting light of an LED to pass therethrough to a limited extent. For example, the LED light transmitting layer 138c may be formed from a translucent material. The position and distribution of the LED light transmitting layer 138c relative to the ink layer 138a and the reinforcement layer 12a are not limited and may be the same or similar to the position and distribution of the infrared light transmitting layer 138b, thus not describing in detail here. Note, though not shown in FIG. 23, the LED light transmitting layer 138c and the infrared light transmitting layer 138b may be both disposed on the glass block 20a.

Further, the glass block 20a may be machined to have at least one chamfered edge, or the glass block 20a does not have any chamfered edge. The ink layer 138a, the infrared light transmitting layer 138b and the LED light transmitting layer 138c may be disposed on the glass block 20a with or without a chamfered edge. Besides, the shape of the reinforcement layer 12a shown in the drawing is only for the sake of illustration but does not limit the scope of the invention.

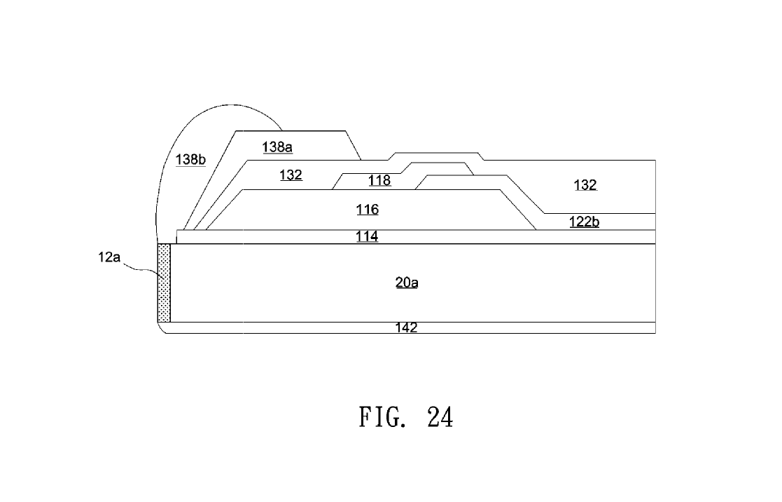

In one embodiment, as shown in FIG. 24, at least one functional film 142 may be disposed on one side of the glass block 20a facing away from the touch-sensing structure and the sheltering layer 138, and the functional film 142 may include, but is not limited to, at least one of an anti-reflection film, a surface tension film, and a hard coat film. The anti-reflection film may be used to reduce glare, and the surface tension film may be used to reduce imprints of one's fingers. Typically, one may test a surface tension film for the effect of reducing imprints by dropping a water droplet on the surface tension film to see whether a contact angle of the water droplet on the surface tension film is larger than 100 degrees. In one embodiment, the functional film 142 may overlap at least a part of the reinforcement layer 12a. Alternatively, the functional film 142 may be covered by a part of the reinforcement layer 12a.

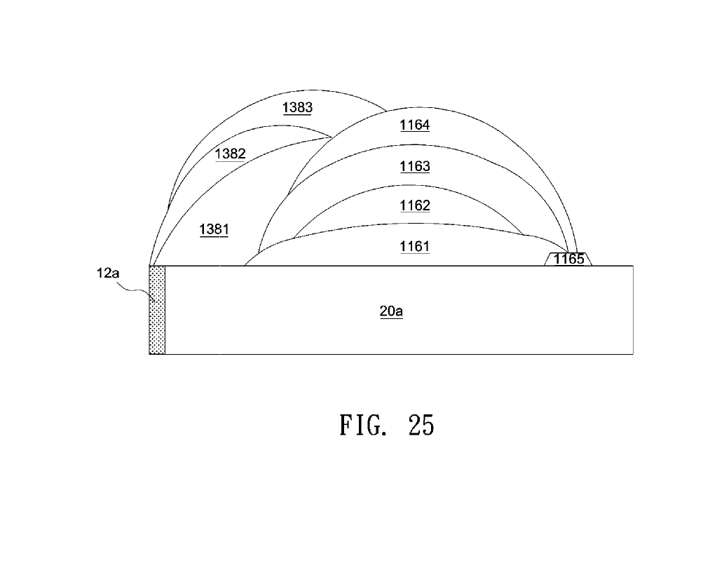

As mentioned above, the decorative layer 116 and the sheltering layer 138 may be a multi-layer structure formed from the same material, different materials, the same color, or different colors. Therefore, as shown in FIG. 25, in one embodiment, the sheltering layer 138 may include a white ink layer 1381, a white ink layer 1382 and a white layer 1383 disposed on the glass block 20a in succession. The decorative layer 116 may be a stack-up structure including a white ink layer 1161, a white ink layer 1162, a white ink layer 1163, and a black photoresist layer 1164 disposed on the glass block 20a in succession. Besides, the decorative layer 116 may further includes a light-shielding block 1165 disposed beside the stack-up structure. In one embodiment, the multi-layer structure of each of the decorative layer 116 and the sheltering layer 138 may include different layers with an identical color or include both a dark layer (such as a black or a gray ink layer) and a non-dark layer (such as a transparent, a white, or a colored ink layer) to provide various visual and light-shielding effects according to actual demands. Certainly, according to various embodiments of the invention, the number, distribution and position of the dark layer and the non-dark layer are not restricted. Note the thickness, size and proportion of each layer shown in the drawings are only for illustration purposes but not actual thickness, size and relative proportion. Further, the glass-strengthening coating material 12 may be applied to a glass block 20a cut from a mother glass substrate that is not subject to a chemically strengthened treatment. Beside, the glass-strengthening coating material 12 may be applied to a cut facet immediately after cutting, applied to a cut facet after peripheral cracks on the cut facet are removed by etching, applied to a cut facet after an ion-exchange treatment is performed to form a chemically strengthened layer on the cut facet, or applied to a cut facet after the peripheral cracks on the cut facet are removed by etching and then an ion-exchange treatment is performed to form a chemically strengthened layer on the cut facet. Note a newly-born surface area is not limited to be formed by cutting and the above treatments of the glass-strengthening coating material 12 can be given to any newly-born surface area that is formed as result of any machining or material removing process.

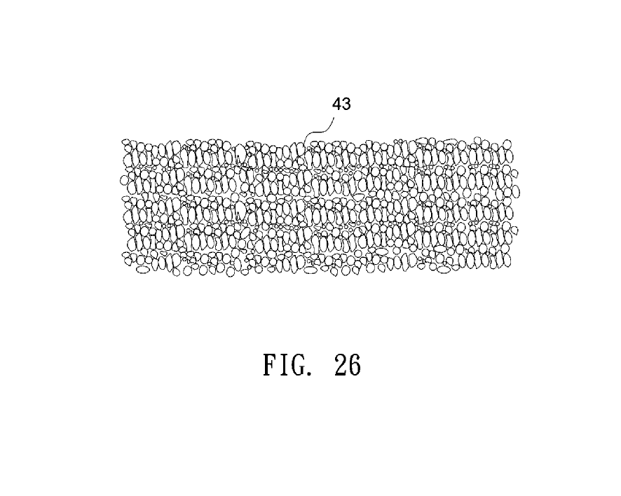

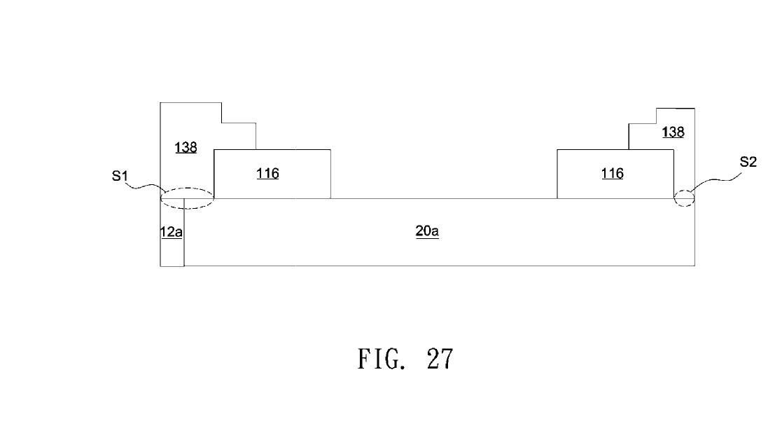

As shown in FIG. 26, a plurality of etched notch structures 43 having an arc-shaped or a tooth-shaped profile are formed in a newly-born surface area such as a cut facet. The etching agent may be a dry etching agent or a wet etching agent. For example, the dry etching agent may be fluorine-containing gas or plasma, and the wetting agent may be a solvent containing hydrofluoric acid or fluorine. Further, as mentioned above, the reinforcement layer 12a may be disposed on only a part of a cut facet of the glass block 20a. Therefore, in one embodiment shown in FIG. 27, the glass block 20a has two opposite ends, and the reinforcement layer 12a may be, for example, disposed only on at least a part of the left-side cut facet but not disposed on the right-side cut facet. In that case, the left-side outer edge of the decorative layer 116 keeps a distance from the outer edge of the reinforcement layer 12a to form a left-side gap region S1, the right-side outer edge of the decorative layer 116 keeps a distance from the right-side cut facet to form a right-side gap region S2, a left part of the sheltering layer 138 may cover the left side gap region S1, and a right part of the sheltering layer 138 may cover the right side gap region S2 to relieve or solve peripheral light leakage. Note the sheltering layer 138 may entirely cover or partially cover the gap regions S1 and S2 to provide light-shielding effects. Moreover, as mentioned above, the decorative layer 116 and the sheltering layer 138 may surround the touch-sensing structure in a viewing area to have an annular shape. However, since FIG. 27 is a schematic cross-section, it should be noted that only a left-side block and a right-side block of the decorative layer 116 and the sheltering layer 138 are shown in FIG. 27.

What is claimed is:

1. A strengthened glass article, comprising:
a glass block having at least one cut facet;
a reinforcement layer at least disposed on at least a part of the cut facet; and
a sheltering layer at least disposed on at least a part of a periphery of the glass block and covering at least a part of the reinforcement layer.

2. The strengthened glass article as claimed in claim 1, further comprising:
a plurality of etched notch structures formed on the cut facet, wherein at least a part of the reinforcement layer is disposed on the etched notch structures.

3. The strengthened glass article as claimed in claim 1, wherein the glass block has at least one newly-born surface area formed as a result of a machining or material removing treatment, the newly-born surface area comprises the cut facet, and the reinforcement layer is disposed on at least a part of the newly-born surface area.

4. The strengthened glass article as claimed in claim 1, wherein the reinforcement layer is further disposed on at least a part of a periphery of the glass block.

5. The strengthened glass article as claimed in claim 1, wherein the reinforcement layer is formed from a material selected from the group consisting of inorganic polymer, organic polymer, and organic/inorganic hybrid polymer.

6. The strengthened glass article as claimed in claim 1, wherein the sheltering layer comprises at least one of ceramic, diamond-like carbon, ink, photoresist and resin.

7. The strengthened glass article as claimed in claim 1, wherein the sheltering layer comprises a translucent material, an opaque material, a material having low light transmittance, or a material capable of transmitting infrared light.

8. The strengthened glass article as claimed in claim 1, wherein the sheltering layer is a multi-layer structure formed from different materials.

9. The strengthened glass article as claimed in claim 1, wherein the sheltering layer is a multi-layer structure formed from the same material.

10. The strengthened glass article as claimed in claim 1, further comprising:
at least one functional film disposed on one side of the glass block facing away from the sheltering layer.

11. The strengthened glass article as claimed in claim 1, further comprising:
a decorative layer disposed on at least a part of a periphery of the glass block, wherein a gap region is formed between an outer edge of the decorative layer and an outer edge of the reinforcement layer, and the sheltering layer covers the gap region at least in part.

12. The strengthened glass article as claimed in claim 1, further comprising:
a touch-sensing structure disposed on the glass block.

13. The strengthened glass article as claimed in claim 1, wherein the glass block is a transparent substrate of a display panel, a substrate of a touch panel, or a cover lens of a touch panel.

14. The strengthened glass article as claimed in claim 1, further comprising:
a display unit disposed on the glass block.

15. A strengthened glass article, comprising:
a glass block cut from a mother glass substrate given a preliminary chemically strengthening treatment, the glass block having a preliminary strengthened surface area and at least one newly-born surface area, and the newly-born surface area being formed as a result of a machining or material removing treatment;
a reinforcement layer at least disposed on at least a part of the newly-born surface area; and
a sheltering layer at least disposed on at least a part of a periphery of the glass block and covering at least a part of the reinforcement layer.

16. The strengthened glass article as claimed in claim 15, wherein the preliminary strengthened surface area is larger than the newly-born surface area.

17. The strengthened glass article as claimed in claim 15, wherein the machining or material removing treatment comprises at least one of cutting, edging, drilling, chamfering, etching and polishing.

18. The strengthened glass article as claimed in claim 15, wherein a plurality of etched notch structures are formed in the newly-born surface area.

19. The strengthened glass article as claimed in claim 18, wherein the etched notch structures are formed by etching using a dry etching agent or a wet etching agent, the dry etching agent is fluorine-containing gas or plasma, and the wetting agent is a solvent containing hydrofluoric acid or fluorine.

20. The strengthened glass article as claimed in claim 15, wherein the reinforcement layer is further disposed on at least a part of the preliminary strengthened surface area.

21. The strengthened glass article as claimed in claim 15, wherein the reinforcement layer is formed from a material selected from the group consisting of inorganic polymer, organic polymer, and organic/inorganic hybrid polymer.

22. The strengthened glass article as claimed in claim 15, wherein the sheltering layer comprises at least one of ceramic, diamond-like carbon, ink, photoresist and resin.

23. The strengthened glass article as claimed in claim 15, wherein the sheltering layer comprises a translucent material, an opaque material, a material having low light transmittance, or a material capable of transmitting infrared light.

24. The strengthened glass article as claimed in claim 15, wherein the sheltering layer is a multi-layer structure formed from different materials.

25. The strengthened glass article as claimed in claim 24, wherein the different materials of the sheltering layer comprises at least two materials selected from the group consisting of a translucent material, an opaque material, a material having low light transmittance, and a material capable of transmitting infrared light.

26. The strengthened glass article as claimed in claim 25, wherein the multi-layer structure comprises an ink layer and an infrared light transmitting layer.

27. The strengthened glass article as claimed in claim 26, wherein the infrared light transmitting layer covers at least a part of the ink layer.

28. The strengthened glass article as claimed in claim 26, wherein at least one of the ink layer and the infrared light transmitting layer covers at least a part of the reinforcement layer.

29. The strengthened glass article as claimed in claim 28, wherein at least one of the ink layer and the infrared light transmitting layer touches at least a part of the reinforcement layer.

30. The strengthened glass article as claimed in claim 28, wherein at least one of the ink layer and the infrared light transmitting layer overlaps at least a part of the reinforcement layer.

31. The strengthened glass article as claimed in claim 24, wherein the multi-layer structure comprises an ink layer and an LED light transmitting layer.

32. The strengthened glass article as claimed in claim 31, wherein the LED light transmitting layer is formed from a translucent material.

33. The strengthened glass article as claimed in claim 31, wherein the LED light transmitting layer covers at least a part of the ink layer.

34. The strengthened glass article as claimed in claim 31, wherein at least one of the ink layer and the LED light transmitting layer covers at least a part of the reinforcement layer.

35. The strengthened glass article as claimed in claim 34, wherein at least one of the ink layer and the LED light transmitting layer touches at least a part of the reinforcement layer.

36. The strengthened glass article as claimed in claim 34, wherein at least one of the ink layer and the LED light transmitting layer overlaps at least a part of the reinforcement layer.

37. The strengthened glass article as claimed in claim 15, wherein the sheltering layer is a multi-layer structure formed from the same material.

38. The strengthened glass article as claimed in claim 37, wherein the same material is ink.

39. The strengthened glass article as claimed in claim 15, wherein the sheltering layer is a multi-layer structure comprising at least one dark layer and at least one non-dark layer.

40. The strengthened glass article as claimed in claim 39, wherein the non-dark layer is a white ink layer or a colored ink layer.

41. The strengthened glass article as claimed in claim 15, further comprising:
at least one functional film disposed on one side of the glass block facing away from the sheltering layer.

42. The strengthened glass article as claimed in claim 41, wherein the functional film is a surface tension film.

43. The strengthened glass article as claimed in claim 41, wherein the functional film and the reinforcement layer are overlapped with each other.

44. The strengthened glass article as claimed in claim 15, further comprising:
a decorative layer disposed on at least a part of a periphery of the glass block, wherein a gap region is formed between an outer edge of the decorative layer and an outer edge of the reinforcement layer, and the sheltering layer covers the gap region at least in part.

45. The strengthened glass article as claimed in claim 44, wherein the sheltering layer has an annular shape and surrounds the decorative layer.

46. The strengthened glass article as claimed in claim 44, where in the glass block is a cover glass and a touch-sensing structure is disposed on the cover glass.

47. The strengthened glass article as claimed in claim 21, wherein the organic polymer is UV curable resin.

48. The strengthened glass article as claimed in claim 15, further comprising:
a touch-sensing structure disposed on the glass block.

49. The strengthened glass article as claimed in claim 15, wherein the glass block is a transparent substrate of a display panel, a substrate of a touch panel, or a cover lens of a touch panel.

50. The strengthened glass article as claimed in claim 15, further comprising:
a display unit disposed on the glass block.

51. A touch-sensitive device, comprising:
a glass block cut from a mother glass substrate given a preliminary chemically strengthening treatment, the glass block having a preliminary strengthened surface area and at least one newly-born surface area, and the newly-born surface area being formed as a result of a machining or material removing treatment;
a touch-sensing structure disposed on the glass block;
a reinforcement layer at least disposed on at least a part of the newly-born surface area;
a decorative layer disposed on the glass block, wherein a gap region is formed between an outer edge of the decorative layer and an outer edge of the reinforcement layer; and
a sheltering layer at least disposed on the glass block and covering the gap region at least in part.

52. A touch-sensitive device, comprising:
a glass block having at least one cut facet;
a touch-sensing structure disposed on the glass block;
a reinforcement layer at least disposed on at least a part of the cut facet of the glass block;
a decorative layer disposed on at least a part of a periphery of the glass block, wherein a gap region is formed between an outer edge of the decorative layer and the cut facet of the glass block; and
a sheltering layer disposed on the glass block and covering the gap region at least in part.
